(19) United States
(12) Patent Application Publication
(10) Pub. No.: US 2013/0302701 A1
(43) Pub. Date: Nov. 14, 2013

(54) NON-AQUEOUS ELECTROLYTE FOR SECONDARY BATTERIES AND NON-AQUEOUS ELECTROLYTE SECONDARY BATTERY

(71) Applicant: Masaki Deguchi, Hyogo (JP)

(72) Inventor: Masaki Deguchi, Hyogo (JP)

(73) Assignee: PANASONIC CORPORATION, Osaka (JP)

(21) Appl. No.: 13/980,690

(22) PCT Filed: Feb. 15, 2012
(86) PCT No.: PCT/JP2012/000979

§ 371 Date: Jul. 19, 2013

(30) Foreign Application Priority Data
Jul. 29, 2011 (JP) 2011-167307

(51) Int. Cl. H01M 10/0569; H01M 10/052

(52) U.S. Cl. CPC H01M 10/0569; H01M 10/052
USPC 429/331

(57) ABSTRACT

A non-aqueous electrolyte for secondary batteries comprising a non-aqueous solvent and a lithium salt dissolved in the non-aqueous solvent, the non-aqueous solvent including ethylene carbonate, propylene carbonate, and a fluorinated aromatic compound having an alkynyl group, a content W_{EC} of ethylene carbonate being 5 to 35 mass %, and a content W_{PC} of propylene carbonate being 15 to 60 mass % in the non-aqueous solvent. The fluorinated aromatic compound having an alkynyl group may be an aromatic compound having 6 to 14 carbon atoms, 1 to 3 fluorine atoms, and an alkynyl group having 2 to 6 carbon atoms.

### TECHNICAL FIELD

The present invention relates to a non-aqueous electrolyte for secondary batteries and a non-aqueous electrolyte secondary battery, and particularly relates to an improvement of a non-aqueous electrolyte including propylene carbonate (PC).

### BACKGROUND ART

In non-aqueous electrolyte secondary batteries represented by lithium ion secondary batteries, a non-aqueous solvent solution of a lithium salt is used as a non-aqueous electrolyte. Examples of the non-aqueous solvent include cyclic carbonates such as ethylene carbonate (EC) and PC, and chain carbonates such as ethyl methyl carbonate (EMC), dimethyl carbonate (DMC), and diethyl carbonate (DEC). In general, two or more carbonates are combined in many cases. It is also known to add an additive to the non-aqueous electrolyte in order to improve battery characteristics.

Among the carbonates, PC has been considered promising. However, PC is incompatible with carbon materials and can be hardly combined with a negative electrode using graphite. Therefore, it is considered to use EC as the main component of the non-aqueous solvent in place of PC.

Patent Literature 1 discloses to add a vinylene carbonate compound and an alkyne compound such as 2-propynyl methyl carbonate to a non-aqueous solvent including EC. In Example, a non-aqueous solvent including EC and a chain carbonate such as EMC, DMC, or DEC, both in high proportions, is used. Patent Literature 1 discloses that since a coating film is formed on the surface of the negative electrode by combining the vinylene carbonate compound and the alkyne compound, the decomposition of the non-aqueous electrolyte is suppressed, and the exhaustion of the non-aqueous electrolyte can be suppressed even in batteries having high capacity.

### CITATION LIST

### Patent Literature

[Patent Literature 1] Japanese Laid-Open Patent Publication No. 2010-182688

### SUMMARY OF INVENTION

### Technical Problem

Although EC has a high dielectric constant and is appropriate for achieving a high lithium ion conductivity, EC has a relatively high melting point and tends to have a high viscosity at low temperatures. Meanwhile, chain carbonates have a low viscosity although they do not have such a high dielectric constant.

In the non-aqueous solvent of Patent Literature 1, although the proportion of EC is high, the proportion of the chain carbonates such as EMC and DMC are also high. Therefore, the decline of rate characteristics at low temperatures associated with the viscosity of EC can be suppressed to some extent. However, if the proportion of the chain carbonates is high, particularly when the battery is stored in a high temperature environment or charge and discharge are repeated, a large amount of gas is produced, thereby to decrease the charge and discharge capacity of the battery. This is because the chain carbonates tend to produce gases by oxidative decomposition and reductive decomposition. As the decomposition of the non-aqueous solvent progresses, the cycle characteristics decline because of increased polarization in the positive electrode and/or the negative electrode, or shortage of the non-aqueous electrolyte. Further, when a lithium-containing transition metal oxide including Ni is used as the positive electrode active material, the production of gases caused by the decomposition of EC is likely to be significant.

In Patent Literature 1, since a protective coating film derived from the vinylene carbonate compound and the alkyne compound is formed on the negative electrode, the reductive decomposition in the negative electrode can be suppressed to some extent. However, vinylene carbonate itself is susceptible to oxidative decomposition in the positive electrode, resulting in the production of gases.

Meanwhile, PC has high resistance to oxidative decomposition in the positive electrode as compared with the chain carbonates, but it is susceptible to reductive decomposition in the negative electrode. Thus, as in Patent Literature 1, even when an alkyne compound such as 2-propynyl methyl carbonate is used, the reductive decomposition of PC cannot be suppressed sufficiently. Consequently, even when the alkyne compound as above is used, the proportion of PC relative to the chain carbonates cannot be increased, and it is difficult to suppress the oxidative decomposition of the non-aqueous solvent in the positive electrode.

Near the end of the cycles of charge and discharge repeated for a long time, lithium metal may be deposited on the surface of the negative electrode at a non-reaction portion derived from production of gases, etc. between the positive and negative electrodes. The lithium metal has very high reactivity with the non-aqueous solvent and may lower the safety of the battery. In a coating film of the vinylene carbonate compound or the alkyne compound such as 2-propynyl methyl carbonate, as in Patent Literature 1, it is difficult to suppress effectively the reaction between the deposited lithium and the non-aqueous solvent. In view of suppressing the reaction between the deposited lithium and the non-aqueous solvent, high safety is required for the negative electrode even near the end of the cycles when the deposition of lithium is significant.

### Solution to Problem

An object of the present invention is to provide a non-aqueous electrolyte for secondary batteries and a non-aqueous electrolyte secondary battery that can remarkably suppress the production of gasses even when the non-aqueous solvent includes a large amount of PC.

An aspect of the present invention relates to a non-aqueous electrolyte for secondary batteries comprising a non-aqueous solvent and a lithium salt dissolved in the non-aqueous solvent, the non-aqueous solvent including ethylene carbonate, propylene carbonate, and a fluorinated aromatic compound having an alkynyl group, and a content W_{EC} of the ethylene carbonate being 5 to 35 mass % and a content W_{PC} of the propylene carbonate being 15 to 60 mass % in the non-aqueous solvent.

Another aspect of the present invention relates to a non-aqueous electrolyte secondary battery comprising: a positive electrode; a negative electrode; a separator interposed between the positive electrode and the negative electrode; and the non-aqueous electrolyte, the negative electrode including a negative electrode current collector and a negative electrode material mixture layer adhering to the negative electrode current collector, and the negative electrode material mixture layer including graphite particles, a water-soluble polymer that coats surfaces of the graphite particles, and a binder that bonds the graphite particles coated with the water-soluble polymer.

### Advantageous Effects of Invention

According to the present invention, since the content of PC in the non-aqueous solvent is high, the non-aqueous solvent has high resistance to oxidative decomposition. Further, since the non-aqueous solvent includes a fluorinated aromatic compound having an alkynyl group, the resistance to reductive decomposition of the non-aqueous solvent can be improved.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWING

FIG. 1 A vertical sectional view schematically illustrating an example of a non-aqueous electrolyte secondary battery of the present invention.

### DESCRIPTION OF EMBODIMENT

### (Non-Aqueous Electrolyte)

A non-aqueous electrolyte for secondary batteries includes a non-aqueous solvent and a lithium salt dissolved in the non-aqueous solvent. The non-aqueous solvent includes ethylene carbonate, propylene carbonate, and a fluorinated aromatic compound having an alkynyl group.

As the fluorinated aromatic compound having an alkynyl group, for example an aromatic compound having a fluorine atom and an alkynyl group as substituents can be used. The number of the fluorine atom can be selected, for example from a range of about 1 to 6, preferably 1, 2, 3, or 4, according to the number of carbon atoms of the aromatic compound.

Examples of the alkynyl group include straight or branched chain alkynyl groups such as ethynyl, 1-propynyl, 2-propynyl, 1-methyl-2-propynyl, 1-butynyl, 2-butynyl, and 3-butynyl.

The alkynyl group has, for example 2 to 8 carbon atoms, preferably 2 to 6 carbon atoms, more preferably 2, 3, or 4 carbon atoms. The fluorinated aromatic compound has about 1, 2, or 3 alkynyl groups.

Examples of the aromatic compound include compounds having a skeleton of an aromatic ring, for example an arene ring, such as benzene and naphthalene; and a bis-arene ring, such as biphenyl and diphenylmethane. The aromatic compound has, for example 6 to 20 carbon atoms, preferably 6 to 14 carbon atoms, more preferably 6 to 10 carbon atoms. The aromatic compound may have a substituent other than the fluorine atom and the alkynyl group, such as an alkyl group (e.g. C₁₋₄ alkyl group such as methyl group). Among the aromatic compounds, benzene, naphthalene, biphenyl, etc. are preferable, and benzene is particularly preferable.

As the fluorinated aromatic compound having an alkynyl group, an aromatic compound having 6 to 14 carbon atoms, 1 to 3 fluorine atoms and an alkynyl group having 2 to 6 carbon atoms is particularly preferable. Above all, 1-ethynyl-2-fluorobenzene, 1-ethynyl-3-fluorobenzene, 1-ethynyl-4-fluorobenzene, 1-propynyl-4-fluorobenzene, 2-propynyl-4-fluorobenzene, etc. are preferable. The fluorinated aromatic compound having an alkynyl group can be used singly or in combination of two or more.

In the present invention, since the fluorinated aromatic compound having an alkynyl group is used, the resistance to reductive decomposition of the non-aqueous solvent can be improved. This is because a stable coating film derived from the fluorinated aromatic compound (e.g. organic coating film derived from alkynyl group or inorganic coating film of LiF, etc.) is formed on the surface of the negative electrode at a relatively high potential (1.2 V or more on Li standard) at an initial period of the charge. Further, by the formation of the coating film, the reductive decomposition of PC in the negative electrode can be suppressed even when the content of PC in the non-aqueous solvent is high.

Even in the case where lithium metal deposits on the surface of the negative electrode, a protective coating film is formed on the surface of the lithium metal by the reaction between the lithium metal and the fluorinated aromatic compound (or decomposed product or polymer thereof). Consequently, even near the end of the cycles where the deposition of lithium is significant, the surface of lithium is coated with the protective coating film, and therefore the reaction between lithium and the non-aqueous solvent (exothermic reaction, etc.) can be suppressed effectively. That is, the stability (heat stability) of the negative electrode can be improved near the end of the cycles.

The content W_{AFA} of the fluorinated aromatic compound having an alkynyl group is, for example 0.1 mass % or more, preferably 0.5 mass % or more in the non-aqueous solvent. With such content, the reductive decomposition of PC in the negative electrode and the production of gases caused thereby can be suppressed more effectively. The upper limit of W_{AFA} is not particularly limited. However, considering that a coating film having an appropriate thickness is formed, the upper limit of W_{AFA} is, for example 5 mass % or less, preferably 3 mass % or less.

In the present invention, since the content of PC in the non-aqueous solvent can be increased, the oxidative decomposition of the non-aqueous solvent in the positive electrode and the production of gases caused thereby can be suppressed remarkably. The content W_{PC} of PC is 15 mass % or more, preferably 20 mass % or more, more preferably 30 mass % or more in the non-aqueous solvent. The upper limit of the content W_{PC} of PC is 60 mass % or less, preferably 50 mass % or less, more preferably 40 mass % or less. These lower and upper limit values can be selected and combined appropriately. When the content W_{PC} is in these ranges, the content of other non-aqueous solvents such as chain carbonates can be reduced, and the decomposition of these solvents and the production of gases caused thereby can be prevented effectively. In the case where a lithium-containing transition metal oxide including Ni is used as the positive electrode active material, the content W_{PC} of PC in the non-aqueous solvent may be selected from the range of, preferably 40 to 60 mass %, more preferably 43 to 57 mass %. When the content W_{PC} is in such ranges, the content of EC can be reduced relatively, and the production of gases caused by the decomposition of EC, etc. can be suppressed more effectively.

The content W_{EC} of EC is 5 mass % or more, preferably 10 mass % or more, more preferably 20 mass % or more in the non-aqueous solvent. Further, the upper limit of the content W_{EC} of EC is 35 mass % or less, preferably 32 mass % or less, more preferably 30 mass % or less. These lower and upper limit values can be selected and combined appropriately. When the content W_{EC} is in such ranges, the decomposition of other non-aqueous solvents such as chain carbonates, and the production of gases caused thereby can be suppressed. In addition, the decline in the ion conductivity of the non-aqueous electrolyte is suppressed, and high rate characteristics can be maintained even at low temperatures. In the case where a lithium-containing transition metal oxide including Ni is used as the positive electrode active material, the content W_{EC} of EC in the non-aqueous solvent may be selected from the range of, preferably 5 to 20 mass %, more preferably 7 to 15 mass %.

As described above, in the present invention, since the decomposition of the non-aqueous solvent can be suppressed in both of the positive electrode and the negative electrode, the polarization in the positive electrode and/or the negative electrode can be suppressed, and the exhaustion of the electrolyte caused by the decrease in the non-aqueous solvent can be prevented. Therefore, the cycle characteristics can be improved. Also, since the production of gases can be suppressed, the decrease in the charge and discharge capacity caused by the production of gases can be suppressed.

The non-aqueous solvent may further include a chain carbonate. Examples of the chain carbonate include alkyl carbonates such as DMC, EMC, and DEC. In the alkyl carbonates, the alkyl has preferably 1 to 4 carbon atoms, more preferably 1, 2, or 3 carbon atoms. These chain carbonates can be used singly or in combination of two or more.

The content W_{CC} of the chain carbonate is, for example 15 to 50 mass %, preferably 20 to 45 mass %, more preferably 25 to 40 mass % in the non-aqueous solvent. When the content W_{CC} is in such ranges, it is advantageous in suppressing the decomposition of the chain carbonates and the production of gases caused thereby; and in suppressing the deterioration of the rate characteristics at low temperatures because the viscosity of the non-aqueous electrolyte can be reduced to a low level. In the case where a lithium-containing transition metal oxide including Ni is used as the positive electrode active material, the content W_{CC} of the chain carbonate in the non-aqueous solvent can be selected from the range of, preferably 15 to 40 mass %, more preferably 20 to 35 mass %.

The non-aqueous solvent may include other non-aqueous solvents as necessary. Examples of the other non-aqueous solvents include cyclic carboxylic acid esters such as γ-butyrolactone and γ-valerolactone; chain carboxylic acid esters such as methyl acetate; chain ethers such as 1,2-dimethoxyethane and pentafluoropropyl methyl ether; and cyclic ethers such as 1,4-dioxane. These other non-aqueous solvents may be used singly or in combination of two or more. The content of the other non-aqueous solvents is, for example 5 mass % or less (0 to 5 mass %), preferably 0.1 to 3 mass % in the non-aqueous solvent.

The non-aqueous electrolyte may include, as necessary, a known additive such as a sultone compound, cyclohexylbenzene, and diphenyl ether. The sultone compound is capable of forming a coating film on the positive electrode. In the present invention, it is not particularly necessary to add an additive that is capable of forming a coating film on the positive electrode because the content of PC in the non-aqueous solvent is high and the decomposition in the positive electrode is suppressed. However, the use of such an additive is not to be avoided. The content of the additive is, for example 10 mass % or less in the non-aqueous electrolyte.

Examples of the lithium salt include lithium salts of fluorine-containing acid (e.g., LiPF₆, LiBF₄, LiCF₃SO₃), and lithium salts of fluorine-containing acid imide (e.g., LiN(CF₃SO₂)₂). The lithium salts may be used singly or in combination of two or more. The concentration of the lithium salts in the non-aqueous electrolyte is, for example 0.5 to 2 mol/L.

The non-aqueous electrolyte can be prepared by a conventional method, for example, by mixing a non-aqueous solvent and a lithium salt to dissolve the lithium salt in the non-aqueous solvent. The order of mixing each solvent and each component is not particularly limited.

Since the above non-aqueous electrolyte can suppress the reaction between the non-aqueous solvent included in the non-aqueous electrolyte and the positive electrode and/or the negative electrode, the production of gasses caused by the decomposition of the non-aqueous solvent can be suppressed remarkably. Therefore, the decline in the charge and discharge capacity can be prevented. Further, since the above non-aqueous electrolyte has low viscosity, it can maintain high ion conductivity even at low temperatures. Thus, the decline in the rate characteristics can be suppressed. Therefore, it is advantageous to use the above non-aqueous electrolyte in non-aqueous electrolyte secondary batteries such as lithium ion secondary batteries.

### (Non-Aqueous Electrolyte Secondary Battery)

A non-aqueous electrolyte secondary battery of the present invention comprises a positive electrode, a negative electrode, and a separator interposed between the positive electrode and the negative electrode together with the above non-aqueous electrolyte.

### (Positive Electrode)

The positive electrode includes a positive electrode active material such as a lithium-containing transition metal oxide. The positive electrode usually includes a positive electrode current collector and a positive electrode material mixture layer adhering to the surface of the positive electrode current collector. The positive electrode current collector may be a non-porous conductive substrate (metal foil, metal sheet, etc.), or a porous conductive substrate (punching sheet, expanded metal, etc.) having a plurality of through holes.

Examples of metal material used for the positive electrode current collector include stainless steel, titanium, aluminum, and an aluminum alloy.

In view of the strength and the lightness of the positive electrode, the positive electrode current collector has a thickness of, for example 3 to 50 μm.

The positive electrode material mixture layer may be formed on one surface of the positive electrode current collector, or may be formed on both surfaces thereof. The positive electrode material mixture layer includes a positive electrode active material and a binder. The positive electrode material mixture layer may further include a thickener, a conductive material, etc. as necessary.

Examples of the positive electrode active material include transition metal oxides that are generally used in the field of the non-aqueous electrolyte secondary batteries, for example lithium-containing transition metal oxides.

Examples of the transition metal elements include Co, Ni, and Mn. These transition metals may be partly replaced by different elements. The different elements are at least one selected from Na, Mg, Sc, Y, Cu, Fe, Zn, Al, Cr, Pb, Sb, and B. The positive electrode active material may be used singly or in combination of two or more.

Specific examples of the positive electrode active material include LiₓNi_{y}M_{z}Me_{1-(y+z)}O_{2+d}, LiₓM_{y}Me_{1-y}O_{2+d}, and LiₓMn₂O₄.

M is at least one element selected from the group consisting of Co and Mn. Me is the above different element and preferably at least one metal element selected from the group consisting of Al, Cr, Fe, Mg, and Zn.

In the above formulae, x satisfies 0.98≦x≦1.2, y satisfies 0.25≦y≦1 or 0.3≦y≦1, z satisfies 0≦z≦0.7 or 0≦z≦0.75.

Provided that y+x satisfies 0.9≦(y+z)≦1, preferably 0.93≦(y+z)≦0.99. d satisfies −0.01≦d≦0.01.

In the above formulae, x preferably satisfies 0.99≦x≦1.1.

y preferably satisfies 0.7≦y≦0.9, more preferably 0.75≦y≦0.85. z preferably satisfies 0.05≦z≦0.4, more preferably 0.1≦z≦0.25.

It is also preferable that y satisfies 0.25≦y≦0.5 (particularly 0.3≦y≦0.4). Also, it is preferable that z satisfies 0.5≦z≦0.75 (particularly 0.6≦z≦0.7). In this case, the element M may be a combination of Co and Mn. Herein, the molar ratio Co/Mn of Co and Mn satisfies 0.2≦Co/Mn≦4, preferably 0.5≦Co/Mn≦2, more preferably 0.8≦Co/Mn≦1.2.

In the present invention, since the content of EC can be relatively low by increasing the content of PC, the production of gases can be suppressed greatly even when a lithium-containing transition metal oxide including Ni that is likely to decompose EC is used as the positive electrode active material. Such a lithium-containing transition metal oxide corresponds to LiₓNi_{y}M_{z}Me_{1-(y+z)}O_{2+d}, among the above positive electrode active materials. The lithium-containing transition metal oxide including Ni is advantageous also in the point of having high capacity.

Examples of the binder include fluorocarbon resins such as polytetrafluoroethylene and polyvinylidene fluoride; polyolefin resins such as polyethylene and polypropylene; acrylic resins such as polymethyl acrylate and ethylene-methyl methacrylate copolymer; rubber materials such as styrene-butadiene rubber and acrylic rubber; and mixtures of these materials. The ratio of the binder is, for example 0.1 to 20 parts by mass, preferably 1 to 10 parts by mass relative to 100 parts by mass of the positive electrode active material.

Examples of the conductive material include carbon black; conductive fiber such as carbon fiber and metal fiber; fluorinated carbon; and natural graphite or artificial graphite. The ratio of the conductive material is, for example 0 to 15 parts by mass relative to 100 parts by mass of the positive electrode active material.

Examples of the thickener include cellulose derivatives such as carboxymethyl cellulose; polyC₂₋₄alkylene glycol such as polyethylene glycol; polyvinyl alcohol; and solubilized modified rubber. The ratio of the thickener is, for example 0 to 10 parts by mass relative to 100 parts by mass of the positive electrode active material.

The positive electrode can be formed by preparing a positive electrode slurry including a positive electrode active material and a binder, and applying the positive electrode slurry onto the surface of the positive electrode current collector. The positive electrode slurry usually includes a dispersing medium, and a conductive material and/or a thickener may be added thereto, as necessary. Examples of the dispersing medium include alcohol such as water and ethanol, ether such as tetrahydrofuran, N-methyl-2-pyrrolidone (NMP), and a mixture of these solvents.

The positive electrode slurry can be prepared by a method using a conventional mixer or a kneader. The positive electrode slurry can be applied onto the surface of the positive electrode current collector by a conventional coating method using a variety of coaters, for example. The coating film of the positive electrode slurry is usually dried and rolled. The drying may be air drying, or may be performed by heating or under reduced pressure.

The positive electrode material mixture layer has a thickness of, for example 30 to 100 μm, preferably 50 to 70 μm.

### (Negative Electrode)

The negative electrode includes a negative electrode current collector and a negative electrode material mixture layer adhering to the negative electrode current collector. As the negative electrode current collector, a non-porous or porous conductive substrate mentioned in the description of the positive electrode current collector. Examples of the metal material forming the negative electrode current collector include stainless steel, nickel, copper, a copper alloy, aluminum, and an aluminum alloy. Among these materials, copper or a copper alloy is preferable.

As the negative electrode current collector, copper foil, particularly electrolytic copper foil is preferable. The copper foil may include 0.2 mol % or less of other components than copper. The thickness of the negative electrode current collector can be selected from the range of 3 to 50 μm, for example.

The negative electrode material mixture layer includes graphite particles as the negative electrode active material, a water-soluble polymer coating surfaces of the graphite particles, and a binder bonding the graphite particles coated with the water-soluble polymer. The negative electrode material mixture layer may include a conductive material and/or a thickener as optional components.

The negative electrode material mixture layer can be formed by preparing a negative electrode slurry including a negative electrode active material and a binder, and a conductive material and/or a thickener as necessary, and applying the negative electrode slurry onto the surface of the negative electrode current collector. The negative electrode material mixture layer may be formed on one surface or both surfaces of the negative electrode current collector. The negative electrode slurry usually includes a dispersing medium. The thickener and/or the conductive material is/are usually added to the negative electrode slurry. The negative electrode slurry can be prepared according to the preparation method of the positive electrode slurry. The application of the negative electrode slurry can be performed in the same manner as the application of the positive electrode slurry.

A graphite particle is a generic term of a particle including an area having a graphite structure. Therefore, the graphite particles include particles of natural graphite, artificial graphite, graphitized mesophase carbon, etc. These graphite particles can be used singly or in combination of two or more. By coating the graphite particles with a water-soluble polymer, the reductive decomposition of the non-aqueous solvent in the negative electrode can be suppressed more effectively.

A diffraction image of graphite particles measured by a wide-angle x-ray diffraction includes a peak attributed to a (101) face and a peak attributed to a (100) face. Herein, a ratio of an intensity I(101) of the peak attributed to the (101) face and an intensity I(100) of the peak attributed to the (100) face preferably satisfies 0.01<I(101)/I(100)<0.25, more preferably satisfies 0.08<I(101)/I(100)<0.20. An intensity of a peak means a height of the peak.

In view of slipping properties and filled conditions of the graphite particles, and bonding strength between the graphite particles, the graphite particles have an average particle diameter of, for example 5 to 25 μm, preferably 10 to 25 μm. The average particle diameter means a median diameter (D50) in the volume particle size distribution of the graphite particles. The volume particle size distribution of the graphite particles can be measured by a commercially available particle size distribution measurement apparatus of a laser diffraction type, for example.

The graphite particles have an average circularity of, preferably 0.90 to 0.95, more preferably 0.91 to 0.94. When the average circularity is within the above ranges, the slipping properties of the graphite particles in the negative electrode material mixture layer are improved, which is advantageous in improving the filling properties of the graphite particles, and improving the bonding strength between the graphite particles. The average circularity is represented by 4 nS/L² (S is surface area in orthographic projection image and L is length of perimeter of orthographic image of graphite particles). For example, it is preferable that the average circularity of any 100 graphite particles is within the above ranges.

The graphite particles have a specific surface area S of preferably 3 to 5 m²/g, more preferably 3.5 to 4.5 m²/g. When the specific area is within the above ranges, the slipping properties of the graphite particles in the negative electrode material mixture layer are improved, which is advantageous in improving the bonding strength between the graphite particles. Further, an appropriate amount of the water-soluble polymer that coats surfaces of the graphite particles can be reduced.

The type of the water-soluble polymer is not particularly limited, and examples thereof include cellulose derivatives; polyacrylic acid, polyvinyl alcohol, polyvinyl pyrrolidone, and derivatives thereof. Among these polymers, cellulose derivative and polyacrylic acid are particularly preferable. As the cellulose derivative, methyl cellulose, carboxymethyl cellulose, and Na salt of carboxymethyl cellulose, etc. are preferable. The cellulose derivative has preferably a molecular weight (weight average molecular weight) of 10,000 to 1,000,000. The polyacrylic acid has preferably a molecular weight (weight average molecular weight) of 5,000 to 1,000,000.

In view of obtaining a suitable coating ratio, the amount of the water-soluble polymer included in the negative electrode material mixture layer is, for example 0.5 to 2.5 parts by mass, preferably 0.5 to 1.5 parts by mass relative to 100 parts by mass of the graphite particles.

The surfaces of the graphite particles may be coated by treating with the water-soluble polymer prior to the preparation of the negative electrode slurry. Alternatively, the surfaces of the graphite particles may be coated with the water-soluble polymer by adding the water-soluble polymer in the process of preparing the negative electrode slurry. In the preparation process of the negative electrode slurry, a solvent may be removed from a mixture to dry as necessary, and then the mixture may be dispersed in the dispersing medium.

The graphite particles can be coated by mixing the graphite particles, water, and the water-soluble polymer dissolved in the water, and drying the obtained mixture. For example, an aqueous solution of water-soluble polymer is prepared by dissolving the water-soluble polymer in water. The obtained aqueous solution of water-soluble polymer is mixed with the graphite particles, and subsequently moisture is removed from the mixture to dry. Thus, by drying once the mixture, the water-soluble polymer adheres effectively to the surfaces of the graphite particles, thereby increasing the coating ratio of the surfaces of the graphite particles with the water-soluble polymer.

It is preferable that the viscosity of the aqueous solution of the water-soluble polymer is controlled to 1 to 10 Pa·s at 25° C. The viscosity is measured by using a B-type viscometer and using a spindle of 5 mmΦ at a peripheral velocity of 20 mm/s. The amount of the graphite particles mixed with 100 parts by mass of the aqueous solution of water-soluble polymer is preferably 50 to 150 parts by mass. The drying temperature of the mixture is preferably 80 to 150° C., and the drying time is preferably 1 to 8 hours.

Next, the negative electrode slurry is prepared by mixing the mixture obtained by the drying, the binder, and the dispersing medium. Through this process, the binder adheres to the surfaces of the graphite particles coated with the water-soluble polymer. Since the slipping properties between the graphite particles are favorable, the binder adhering to the surfaces of the graphite particles receives a sufficient shearing force and acts effectively on the surfaces of the graphite particles.

In the case of mixing the graphite particles with the water-soluble polymer, as the solvent, a solvent similar to the dispersing medium (NMP, etc.) may be used, or water, an aqueous solution of alcohol, etc. may be used. As the binder, dispersing medium, conductive material, and thickener, materials similar to those mentioned in the paragraph of the positive electrode slurry can be used.

As the binder, one having a particle form and rubber elasticity is preferable. Examples of such a binder include a polymer having a styrene unit and a butadiene unit (styrene-butadiene rubber, etc.). Such a binder has good elasticity and is stable at the negative electrode potential.

The binder having a particle form has an average particle diameter of, for example 0.1 to 0.3 μm, preferably 0.1 to 0.25 μm. The average particle diameter of the binder can be determined by taking SEM photographs of 10 binder particles by a transmission electron microscope (available from JEOL Ltd., accelerating voltage: 200 kV), and averaging maximum diameters of these binder particles.

The proportion of the binder is, for example 0.4 to 1.5 parts by mass, preferably 0.4 to 1 part by mass relative to 100 parts by mass of the graphite particles. Since the slipping properties between the graphite particles are improved by coating the surfaces of the graphite particles with the water-soluble polymer, the binder adhering to the surfaces of the graphite particles receives a sufficient shearing force and acts effectively on the surfaces of the graphite particles. Further, the binder having a particle form and a small average particle diameter has a high probability of coming in contact with the surfaces of the graphite particles. Therefore, sufficient binding properties can be exhibited even when the amount of the binder is small.

The proportion of the conductive material is not particularly limited and is, for example 0 to 5 parts by mass relative to 100 parts by mass of the negative electrode active material. The proportion of the thickener is not particularly limited and is, for example 0 to 10 parts by mass relative to 100 parts by mass of the negative electrode active material.

The negative electrode can be produced according to the production method of the positive electrode. The negative electrode material mixture layer has a thickness of, for example 30 to 110 μm, preferably 50 to 90 μm.

### (Separator)

Examples of the separator include a porous film including resin (porous film) and nonwoven cloth. Examples of the resin constituting the separator include polyolefin resins such as polyethylene, polypropylene, and ethylene-propylene copolymer. The separator has a thickness of, for example 5 to 100 μm.

### (Others)

The shape of the non-aqueous electrolyte secondary battery is not particularly limited, and it may be cylindrical, flat-type, coin-type, prismatic, etc.

The non-aqueous electrolyte secondary battery can be produced by a conventional method corresponding to the shape and the like of the battery. The cylindrical battery or prismatic battery can be produced, for example, by winding a positive electrode, a negative electrode, and a separator interposed between the positive electrode and the negative electrode, thereby to form an electrode group, and housing the electrode group and a non-aqueous electrolyte in a battery case.

The electrode group is not limited to a wound type, and a laminate type and a zigzag-folded type are also applicable. The shape of the electrode group may be cylindrical, or a flat type whose end face perpendicular to the winding axis is oval, according to the shape of the battery or the battery case.

Examples of the material for the battery case include aluminum, an aluminum alloy (alloy including very small amount of metal such as manganese and copper), and a steel plate.

In the present invention, since a non-aqueous electrolyte including a fluorinated aromatic compound having an alkynyl group is used, if at least one cycle of charge and discharge of the non-aqueous electrolyte secondary battery is performed, a coating film derived from the fluorinated aromatic compound is formed on the surface of the negative electrode material mixture layer. It is preferable that the charge and discharge are performed in the range where the potential of the negative electrode is 0.01 to 1.5 V on the lithium standard. By the formation of this coating film, the production of gases or the exhaustion of electrolyte caused by the decomposition of the non-aqueous solvent can be suppressed. Therefore, the present invention also includes the non-aqueous electrolyte secondary battery that can be obtained by performing at least one cycle of charge and discharge. A content W_{AFA}, in the non-aqueous solvent, of the fluorinated aromatic compound included in the non-aqueous electrolyte of the battery after the charge and discharge after one cycle of the above charge and discharge is performed by using the non-aqueous electrolyte in which the content W_{AFA} of the fluorinated aromatic compound in the non-aqueous solvent is 0.1 to 5 mass % is, for example 0.05 to 4.95 mass %.

### EXAMPLES

The present invention will be described specifically by referring to Examples and Comparative Examples. However, the present invention is not limited to the following Examples.

### Example 1

### (a) Production of Negative Electrode

### Step (i)

Carboxymethyl cellulose (CMC, hereinafter, molecular weight: 400,000) as the water-soluble polymer was dissolved in water to obtain an aqueous solution having a CMC concentration of 1.0 mass %. One hundred parts by mass of natural graphite particles (average particle diameter: 20 μm, average circularity: 0.92, specific surface area: 4.2 m²/g) and 100 parts by mass of aqueous solution of CMC were mixed and stirred while the temperature of the mixture was controlled at 25° C. Subsequently, the mixture was dried at 120° C. for 5 hours to produce a dry mixture. In the dry mixture, the amount of CMC per 100 parts by mass of graphite particles was 1.0 part by mass.

### Step (ii)

A negative electrode slurry was prepared by mixing 101 parts by mass of the obtained dry mixture, 0.6 part by mass of a binder having a particle form, an average particle diameter of 0.12 μm, including a styrene unit and a butadiene unit, and having rubber elasticity (SBR, hereinafter), 0.9 part by mass of CMC, and an appropriate amount of water. SBR was mixed with the other components in the form of emulsion using water as a dispersing medium (SBR content: 40 mass %).

Step (iii)

The obtained negative electrode slurry was applied to both surfaces of electrolytic copper foil (thickness: 12 μm) as a negative electrode core material, and the coating film was dried at 120° C. Subsequently, the dry coating film was rolled with rollers with a linear pressure of 250 kg/cm, thereby producing a negative electrode material mixture layer having a graphite density of 1.5 g/cm³. The thickness of the whole negative electrode was 140 μm. The negative electrode material mixture layer was cut into a predetermined shape together with the negative electrode core material, thereby to produce a negative electrode.

### (b) Production of Positive Electrode

Four parts by mass of PVDF as the binder was added to 100 parts by mass of LiNi_{0.80} Cu_{0.15}Al_{0.05}O₂ as the positive electrode active material, and mixed together with an appropriate amount of NMP, thereby to prepare a positive electrode slurry. The obtained positive electrode slurry was applied onto both surfaces of aluminum foil having a thickness of 20 μm as the positive electrode core material by using a die coater, and the coating film was dried. Further, the coating film was rolled to form a positive electrode material mixture layer. The positive electrode material mixture layer was cut into a predetermined shape together with the positive electrode core material, thereby to produce a positive electrode.

### (c) Preparation of Non-Aqueous Electrolyte

LiPF₆ was dissolved, at a concentration of 1 mol/L, in a mixed solvent including EC, PC, DEC, and 1-ethynyl-4-fluorobenzene (EFB) in a mass ratio of W_{EC}:W_{PC}:W_{DEC}:W_{EFB}=30:30:38:2, thereby to prepare a non-aqueous electrolyte. The viscosity of the non-aqueous electrolyte at 25° C. was measured by a rotational viscometer, and it was 4.8 mPa·s.

### (d) Assembly of Battery

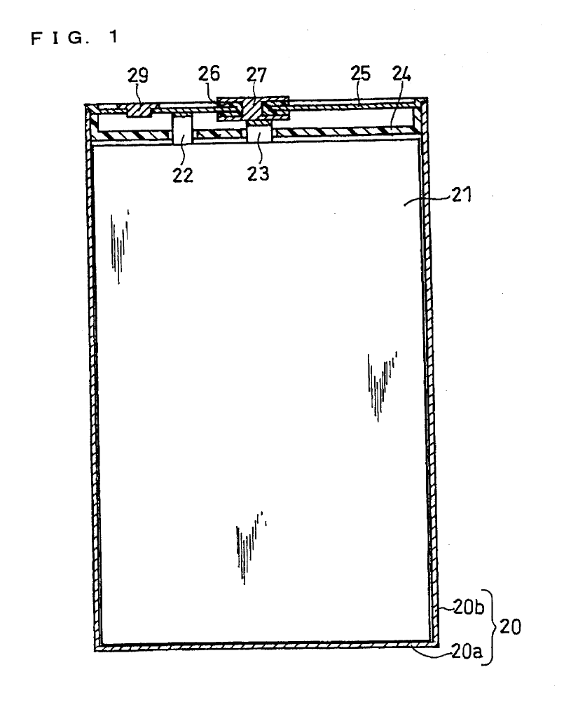

A prismatic lithium ion secondary battery as illustrated in FIG. 1 was produced.

The negative electrode and the positive electrode were wound with a separator made of a microporous film of polyethylene (A089 (trade name), available from Celgard Co., Ltd.) having a thickness of 20 μm, interposed therebetween, thereby producing an electrode group 21 having a roughly oval cross section. The electrode group 21 was housed in a prismatic battery can 20 made of aluminum. The battery can 20 had a bottom portion 20a and a side wall 20b, an open upper portion, and a roughly rectangular shape. The principal flat portion of the side wall had a thickness of 80 μm.

Subsequently, an insulator 24 for preventing short circuit between the battery can 20 and a positive lead 22 or a negative lead 23 was disposed on an upper portion of the electrode group 21. Next, a rectangular sealing plate 25 having a negative terminal 27 at a center thereof, surrounded with an insulating gasket 26 was disposed in an opening of the battery can 20. The negative lead 23 was connected with the negative terminal 27. The positive lead 22 was connected with a lower surface of the sealing plate 25. An end portion of the opening was laser welded with the sealing plate 25, thereby to seal the opening of the battery can 20. Thereafter, 2.5 g of non-aqueous electrolyte was injected into the battery can 20 through an injection hole of the sealing plate 25. Finally, the injection hole was closed with a sealing plug 29 by welding, thereby to complete a prismatic lithium ion secondary battery 1 having a height of 50 mm, a width of 34 mm, a thickness of an inner space of about 5.2 mm, and a design capacity of 850 mAh.

### <Evaluation of Battery>

### (i) Evaluation of Cycle Capacity Retention Rate

A charge and discharge cycle of battery was repeated with the battery 1 at 45° C. In the charge and discharge cycle, as for the charge process, the battery was charged at a constant current of 600 mA to 4.2 V, and next, the battery was charged at a constant voltage of 4.2 V. The charge was performed for a total of 2 hours 30 minutes. A rest time after the charge was set to 10 minutes. As for the discharge process, the battery was discharged at a constant current at a discharge current of 850 mA to an end-of-discharge voltage of 2.5 V. A rest time after the discharge was set to 10 minutes.

The discharge capacity at the 3^{rd} cycle was defined as 100%, and the discharge capacity after 500 cycles was determined as the cycle capacity retention rate [%]. The results are shown in Table 1.

### (ii) Evaluation of Battery Expansion

In a center portion of a 50 mm (length)×34 mm (width) plane of the battery 1, the thickness of the battery in a direction perpendicular to this plane was measured in the condition after the charge of the 3^{rd} cycle and in the condition after the charge of the 501^{st} cycle. From the difference of the thickness of the battery between these conditions, the amount of battery expansion [mm] after the charge and discharge cycles at 45° C. was determined. The results are shown in Table 1.

(iii) Evaluation of Safety (Heat Stability) of Battery

In an environment of −5° C., a constant current charge was performed at a charge current of 600 mA to an end-of-charge voltage of 4.25 V. Subsequently, the temperature of the battery was increased to 130° C. at a temperature rising rate of 5° C./min, and it was maintained at 130° C. for 3 hours. At this time, the temperature on the surface of the battery was measured by using a thermocouple, and the maximum value thereof was determined.

### (iv) Evaluation of Low-Temperature Discharge Characteristics

Three cycles of charge and discharge of the battery was repeated with the battery 1 at 25° C. Next, after the charge process of the 4^{th} cycle was performed at 25° C., the battery was left for 3 hours at 0° C., and then the discharge process was performed at 0° C. as it was. By defining the discharge capacity at the 3^{rd} cycle (25° C.) as 100%, the discharge capacity at the 4^{th} cycle (0° C.) was expressed as a percentage, and this was determined as a low-temperature discharge capacity retention rate [%]. The charge and discharge conditions were made the same as item (i) except for the rest time after the charge.

### Example 2

Non-aqueous electrolytes were prepared in the same manner as in Example 1 except for using the fluorinated aromatic compounds shown in Table 1 were used in place of EFB. Batteries 2 to 5 were produced in the same manner as in Example 1 except for using the obtained non-aqueous electrolytes.

### Comparative Example 1

Non-aqueous electrolytes were prepared in the same manner as in Example 1 except for using the alkyne compounds shown in Table 1 in place of EFB. Batteries 6 and 7 were produced in the same manner as in Example 1 except for using the obtained non-aqueous electrolytes.

### Comparative Example 2

A non-aqueous electrolyte was prepared in the same manner as in Example 1 except for using 2 mass % of vinylene carbonate (VC) together with the alkyne compound shown in Table 1 in place of EFB. Battery 8 was produced in the same manner as in Example 1 except for using the obtained non-aqueous electrolyte.

### Example 3

A non-aqueous electrolyte was prepared in the same manner as in Example 1 except for using EMC in place of DEC. Battery 9 was produced in the same manner as in Example 1 except for using the obtained non-aqueous electrolyte.

The batteries 2 to 9 were evaluated in the same manner as in Example 1. The results are shown in Table 1.

TABLE 1

| | | | | Cycle capacity | Battery expansion | Heat |
|---|---|---|---|---|---|---|
| | Fluorinated aromatic | Chain | VC | retention rate | after cycle | stability |
| | compound or alkyne compound | carbonate | (%) | (%) | (mm) | (° C.) |
| Battery 1 | 1-ethynyl-4-fluorobenzene | DEC | 0 | 86.5 | 0.40 | 131 |
| Battery 9 | 1-ethynyl-4-fluorobenzene | EMC | 0 | 81.3 | 0.49 | 134 |
| Battery 2 | 1-ethynyl-3-fluorobenzene | DEC | 0 | 86.1 | 0.42 | 131 |
| Battery 3 | 1-ethynyl-2-fluorobenzene | DEC | 0 | 86.0 | 0.43 | 131 |
| Battery 4 | 1-propynyl-4-fluorobenzene | DEC | 0 | 85.6 | 0.41 | 131 |
| Battery 5 | 2-propynyl-4-fluorobenzene | DEC | 0 | 85.2 | 0.44 | 132 |
| Battery 6 | 2-propynyl methyl carbonate | DEC | 0 | 52.1 | 1.10 | 170 |
| Battery 7 | ethynylbenzene | DEC | 0 | 55.1 | 1.06 | 173 |
| Battery 8 | 2-propynyl methyl carbonate | DEC | 2 | 60.9 | 1.02 | 171 |

From Table 1, it is found that in all the batteries of Examples using any fluorinated aromatic compound having an alkynyl group, the battery expansion after the charge of the 501^{st} cycles as compared with the battery expansion at the 3^{rd} cycle of the charge and discharge, is suppressed remarkably. The expansion of the batteries of Examples is half or less of the batteries of Comparative Examples using a conventional additive having an alkynyl group but no fluorine atom. Further, the batteries of Examples have capacity retention rate that is 20% or more higher than that in the batteries of Comparative Examples. From these results, it is found that the production of gases is suppressed remarkably as compared with the batteries of Comparative Examples.

In addition, from the results of examination of heat stability, in the batteries of Examples, the temperature on the surface is about 40° C. lower than in the batteries of Comparative Examples. The reason for this is considered that, in Examples, due to the reaction between lithium metal deposited on the surface of the negative electrode and the fluorinated aromatic compound, a protective coating film is formed on the surface of the lithium metal, which suppresses the exothermic reaction in which the lithium metal participates.

### Example 5

Non-aqueous electrolytes were prepared in the same manner as in Example 1 except for changing the ratio of W_{EC}:W_{PC}:W_{DEC}:W_{EFB} as shown in Table 1. Batteries 11 to 18 were produced in the same manner as in Example 1 except for using the obtained non-aqueous electrolytes.

The batteries 15 to 18 are all batteries of Comparative Examples.

The batteries 11 to 18 were evaluated in the same manner as in Example 1. The results are shown in Table 2.

TABLE 2

| | | | Battery | Low-temperature | |
|---|---|---|---|---|---|
| | | Cycle capacity | expansion | capacity | |
| | | retention rate | after cycle | retention rate | Heat stability |
| | W_{EC}:W_{PC}:W_{DEC}:W_{EFB} | (%) | (mm) | (%) | (° C.) |
| Battery 11 | 10:50:38:2 | 86.1 | 0.41 | 81.3 | 136 |
| Battery 12 | 20:40:38:2 | 86.3 | 0.40 | 81.2 | 132 |
| Battery 13 | 30:30:39.5:0.5 | 82.8 | 0.47 | 81.4 | 135 |
| Battery 14 | 30:30:37:3 | 84.0 | 0.44 | 81.5 | 131 |
| Battery 15 | 30:10:58:2 | 51.7 | 1.13 | 83.7 | 131 |
| Battery 16 | 30:65:3:2 | 80.1 | 0.49 | 62.0 | 133 |
| Battery 17 | 3:30:65:2 | 34.1 | 1.03 | 73.9 | 170 |
| Battery 18 | 40:20:38:2 | 83.3 | 0.45 | 63.6 | 131 |

From Table 2, in the batteries of Examples, the battery expansion after cycle is suppressed, and a high capacity retention rate is obtained. Also, in the conditions where lithium metal deposits, the increase in the battery temperature is suppressed. Further, even at a low temperature of 0° C., discharge with a high capacity retention rate is possible, and high rate characteristics can be maintained. In contrast, the batteries 15 and 17 of Comparative Examples having a low content of EC or PC have significant battery expansion, and strikingly lower capacity retention rate. The battery 17 having a low content of EC has lower heat stability, and lower rate characteristics at low temperatures. Also, the batteries 16 and 18 of Comparative Examples having a high content of EC or PC have strikingly lower rate characteristics at low temperatures. From these points, it is found that even when a fluorinated aromatic compound having an alkynyl group is used, the effects of the present invention cannot be obtained depending on the content of EC or PC.

### Example 6

Batteries 19 to 22 were produced in the same manner as in Example 1 except for using materials listed in Table 3 as the water-soluble polymers. All the water-soluble polymers were made to have a molecular weight of about 400,000.

The batteries 19 to 22 were evaluated as in Example 1. The results are shown in Table 3.

TABLE 3

| | | Cycle | | |
|---|---|---|---|---|
| | | capacity | Battery | |
| | | retention | expansion | Heat |
| | Water-soluble | rate | after cycle | stability |
| | polymer | (%) | (mm) | (° C.) |
| Battery 19 | CMC | 86.5 | 0.40 | 131 |
| Battery 20 | Na salt of CMC | 85.2 | 0.42 | 132 |
| Battery 21 | Methyl cellulose | 84.9 | 0.43 | 133 |
| Battery 22 | Polyacrylic acid | 81.7 | 0.47 | 132 |

From Table 3, it is found that, when any of the water-soluble polymers is used, the battery expansion after cycle is suppressed, and a high capacity retention rate and high heat stability can be obtained in the same manner as in the other Examples.

### Example 7

Batteries 23 to 36 were produced in the same manner as in Example 1 except for using materials listed in Table 4 as the positive electrode active materials.

The batteries 23 to 36 were evaluated in the same manner as in Example 1. The results are shown in Table 4.

TABLE 4

| | | Cycle | | |
|---|---|---|---|---|
| | | capacity | Battery | |
| | Positive | retention | expansion | Heat |
| | electrode active | rate | after cycle | stability |
| | material | (%) | (mm) | (° C.) |
| Battery 1 | LiNi_{0.80}Co_{0.15}Al_{0.05}O₂ | 86.5 | 0.40 | 131 |
| Battery 23 | LiNi_{1/3}Co_{1/3}Mn_{1/3}O₂ | 88.0 | 0.38 | 131 |
| Battery 24 | LiCoO₂ | 88.7 | 0.35 | 131 |
| Battery 25 | LiNi_{0.3}Co_{0.7}O₂ | 88.4 | 0.37 | 131 |
| Battery 26 | LiNi_{0.4}Co_{0.6}O₂ | 88.1 | 0.37 | 131 |
| Battery 27 | LiNi_{0.5}Co_{0.5}O₂ | 87.8 | 0.38 | 131 |
| Battery 28 | LiNi_{0.7}Co_{0.3}O₂ | 87.2 | 0.39 | 131 |
| Battery 29 | LiNi_{0.9}Co_{0.1}O₂ | 83.0 | 0.47 | 131 |
| Battery 30 | LiNi_{0.80}Co_{0.15}Mg_{0.05}O₂ | 86.3 | 0.40 | 131 |
| Battery 31 | LiNi_{0.80}Co_{0.15}Zn_{0.05}O₂ | 86.3 | 0.40 | 131 |
| Battery 32 | LiNi_{0.80}Co_{0.15}Cr_{0.05}O₂ | 86.1 | 0.41 | 131 |
| Battery 33 | LiNi_{0.80}Co_{0.15}Fe_{0.05}O₂ | 86.0 | 0.42 | 131 |
| Battery 34 | LiNi_{0.3}Mn_{0.7}O₂ | 80.6 | 0.49 | 131 |
| Battery 35 | LiNi_{0.5}Mn_{0.5}O₂ | 82.0 | 0.46 | 131 |
| Battery 36 | LiNi_{0.5}Mn_{0.4}Co_{0.1}O₂ | 84.2 | 0.44 | 131 |

From Table 4, it is found that, when any of the positive electrode active materials was used, the battery expansion after cycle is suppressed, and a high capacity retention rate and high heat stability can be obtained in the same manner as in the other Examples. Further, the production of gases caused by the decomposition of EC tends to be significant when a lithium-containing transition metal oxide including Ni is used as the positive electrode active material. However, it is found that, even in such cases, the production of gases is suppressed effectively.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

According to the present invention, since the reaction between the non-aqueous solvent and the positive electrode and/or the negative electrode can be suppressed, excellent cycle characteristics can be obtained. In addition, the stability of the negative electrode can be improved even near the end of the cycles. Therefore, the present invention is useful as the non-aqueous electrolyte for secondary batteries used in electronic devices such as cellular phones, personal computers, digital still cameras, game equipment, and portable audio devices.

### REFERENCE SIGNS LIST

20. Battery can
21. Electrode group
22. Positive lead
23. Negative lead
24. Insulator
25. Sealing plate
26. Insulating gasket
29. Sealing plug

1. A non-aqueous electrolyte for secondary batteries comprising a non-aqueous solvent and a lithium salt dissolved in the non-aqueous solvent,
the non-aqueous solvent including ethylene carbonate, propylene carbonate, and a fluorinated aromatic compound having an alkynyl group, and
a content W_{EC} of the ethylene carbonate being 5 to 35 mass % and a content W_{PC} of the propylene carbonate being 15 to 60 mass % in the non-aqueous solvent.

2. The non-aqueous electrolyte for secondary batteries in accordance with claim 1, wherein the fluorinated aromatic compound having an alkynyl group is an aromatic compound having 6 to 14 carbon atoms, 1 to 3 fluorine atoms, and an alkynyl group having 2 to 6 carbon atoms.

3. The non-aqueous electrolyte for secondary batteries in accordance with claim 1, wherein the fluorinated aromatic compound having an alkynyl group is at least one selected from the group consisting of 1-ethynyl-2-fluorobenzene, 1-ethynyl-3-fluorobenzene, and 1-ethynyl-4-fluorobenzene.

4. The non-aqueous electrolyte for secondary batteries in accordance with claim 1, wherein a content W_{AFA} of the fluorinated aromatic compound having an alkynyl group is 0.1 to 5 mass % in the non-aqueous solvent.

5. The non-aqueous electrolyte for secondary batteries in accordance with claim 1, wherein the non-aqueous solvent further includes a chain carbonate.

6. The non-aqueous electrolyte for secondary batteries in accordance with claim 5, wherein a content W_{CC} of the chain carbonate is 15 to 50 mass % in the non-aqueous solvent.

7. A non-aqueous electrolyte secondary battery comprising: a positive electrode;
a negative electrode; a separator interposed between the positive electrode and the negative electrode; and the non-aqueous electrolyte in accordance with claim 1,
the negative electrode including a negative electrode current collector and a negative electrode material mixture layer adhering to the negative electrode current collector, and
the negative electrode material mixture layer including graphite particles, a water-soluble polymer that coats surfaces of the graphite particles, and a binder that bonds the graphite particles coated with the water-soluble polymer.

8. The non-aqueous electrolyte secondary battery in accordance with claim 7, wherein a coating film derived from the fluorinated aromatic compound having an alkynyl group is formed on a surface of the negative electrode material mixture layer.

9. The non-aqueous electrolyte secondary battery in accordance with claim 7, wherein the water-soluble polymer includes at least one selected from the group consisting of a cellulose derivative and polyacrylic acid.

10. The non-aqueous electrolyte secondary battery in accordance with claim 7, wherein the positive electrode includes a lithium-containing transition metal oxide represented by LiₓNi_{y}M_{z}Me_{1-(y+z)}O_{2+d}, where M is at least one element selected from the group consisting of Co and Mn, Me is at least one metal element selected from the group consisting of Al, Cr, Fe, Mg, and Zn, 0.98≦x≦1.2, 0.25≦y≦1, 0≦z≦0.75, 0.9≦(y+z)≦1, and −0.01≦d≦0.01.
